(19) United States
(12) Patent Application Publication
(10) Pub. No.: US 2006/0007130 A1
(43) Pub. Date: Jan. 12, 2006

(54) Data input method and apparatus

(76) Inventor: Donald W. Mosley, Metairie, LA (US)

Correspondence Address: DONALD W. MOSLEY, 2016 GREEN ACRES RD., METAIRIE, LA, 70003, US

(21) Appl. No.: 11/110,576

(22) Filed: May 18, 2005

Related U.S. Application Data
(60) Provisional application No. 60/572,568, filed on May 19, 2004.

(51) Int. Cl. G09G 5/00

(52) U.S. Cl. 345/156

(57) ABSTRACT

A data input method and apparatus for inputting data into any electronic device and the like comprises multiple function, multi-directional [2]. The METHOD is accomplished by manipulating the APPARATUS/multiple function, multi-directional key [2] slightly in any direction [including spherical/3-D] from a center point [8], with the fingers, etc. remaining on the moving surface [4] of the multi-directional key[s], data input is accomplished. The key is returned to the centerpoint/rest position by spring action device [16]. Keeping the fingers, etc. on the key most of the time takes less time and effort to enter data. The method provides that the proper number of multi-directional key[s] with the proper number of multiple functions are available to allow the full functionality of the input device, [devices like computers, typewriters, calculators, telephones, remote controls, limited space mini keyboards, musical data input devices, and any mechanism or device requiring data input.]

### CROSS-REFERENCE TO RELATED APPLICATIONS

Not applicable.

### BACKGROUND

1. Field of Invention

This invention relates generally to a method for inputting data into devices like computers, typewriters, calculators, telephones, remote controls, limited space mini keyboards, musical data input devices, and any mechanism or device requiring data input; more particularly, the present invention relates to a method of manipulating multidirectional keys, touch screen or like sensors, mental or electronic transmissions, and the like so as to control all functions of said electronic devices.

2. Description of Prior Art

Keys and keyboards have been used for many years to input data into devices like computers, typewriters, calculators, telephones, remote controls, limited space mini keyboards, musical data input devices, and any mechanism or device requiring data input.

Many devices and inventions have been made to overcome the burdensome, arduous, and laborious task of inputting data into said mechanisms. Now with limited space for keys and keyboards due to the miniaturization of electronic devices, there is a problem using standard size keys and keyboards. New devices are being invented and made to try and overcome these problems and also limit the number of keys required to perform the necessary tasks. Toggle and multi-directional key switches and new types of data input devices and keyboards have been invented to try and overcome some of the problems associated with the inputting of data

There are no methods of entering data for the aforementioned purposes and scope as described herein with multiple directional keys having multiple function data points thereon.

In U.S. Pat. No. 6,053,646 to KOLSRUD (2000)-[KEYBALL], reflects a different method of entering data to try and simplify the inputing of data but still uses the old thought concept of PRESSING KEYS AS SPECIFICALLY DESCRIBED and does not encompass the idea of using multi-directional multi-function keys.

In U.S. Pat. No. 6,831,238 to LAU (2004)-[FINGER-CONTROLLABLE MULTI-DIRECTIONAL SWITCH]; reflects a different method of entering data by utilizing a multi-directional key with limited multi-functions but only to the extent of limited functions, planar movement. Basically the idea of his invention is to replace movement of cursor over a computer display screen. The invention in no way encompasses the idea of using a multi-directional multi-function keys to input data for a full alphabet or full numerical set of numbers or other types of functions as is necessary to perform all the task functions required for devices like computers, typewriters, calculators, telephones, remote controls, limited space mini keyboards, musical data input devices, and any mechanism or device requiring data input.

Although there are many patents and devices to improve inputting date, no patent suggests or shows the novel features of the DATA INPUT METHOD AND APPARATUS of the present invention. No prior art utilizing MULTI-DIRECTIONAL SWITCHES OR KEYS attempts to offer a method, system, or device to accomplish the tasks necessary to perform all functions required for said computers, typewriters, calculators, telephones, remote controls, limited space mini keyboards, musical data input devices, and any mechanism or device requiring data input. The multi-directional key has never been used or developed to this degree/extent to perform the multiple functions as shown in the present invention.

There is no toggle switch or patent that reveals a method of entering data in the fashion or concept of using multi-directional keys, etc. and to the extent of and for the purpose as described in the present invention.

Although the said devices, inventions, and toggle switches help to some degree, the said devices heretofore known suffer from a number of disadvantages:
(a) They in no way encompass the idea of inputting a full alphabet or full numerical set of numbers or other types of functions as is necessary to perform all functions required for devices like computers, typewriters, calculators, telephones, remote controls, limited space mini keyboards, musical data input devices, and any mechanism or device requiring data input which will reduce the required number of keys considerably.
(b) They require excessive reaching for and pressing of keys, Actions that take more time and effort
(c) They require a minimum size key for the fitting of the fingers thereon, which is a problem when there is a very limited keyboard space.
(d) They require too many keys to perform the tasks required, which is a problem when there is a very limited keyboard space
(e) They require many keys to perform data entry for languages with relatively many characters, which number can be reduces by using the present invention
(f) They do not enter data in the full scope and use as described in the present invention.
(g) They do not offer multi-directional keys that are specifically designed as an apparatus, device, or method to be used for typing as typewriter keyboard keys or for entering numbers as a telephone keypad keys, and the same goes for all other types of uses as shown herein
(h) They are limited because they have not covered the full capacity of the multiple functionality of the multi directional key as described in the present invention.

### SUMMARY

In accordance with the present invention the DATA INPUT METHOD AND APPARATUS comprises a method by which multidirectional keys, touch screen or like sensors, mental or electronic transmissions, and the like can be utilized to effectively and efficiently input the full range of data necessary to complete of tasks of electronic devices like computers, typewriters, calculators, telephones, remote controls, limited space mini keyboards, musical data input devices, and any mechanism or device requiring data input, and so on in an easier way with a lesser number of full functioning keys as is required to date. The data input method and apparatus of the present invention overcomes many of the disadvantages associated with the input methods and apparatus of the background art. A data input method and apparatus for inputting data into any electronic device and the like comprises a multi-directional key [2]. By manipulating the motion/moving surface [4] slightly in any direction [including spherical/3-D] from a center point [6] toward a contact point [8], with the fingers, etc. remaining on the moving surface [4] of the multidirectional key[s], data input is accomplished. The key is restored to the centerpoint/rest position [6] by a spring action device [16]. Keeping the fingers, etc. on the key most of the time takes less time and effort to enter data.

Objects and Advantages

Accordingly, besides the objects and advantages of the DATA INPUT METHOD AND APPARATUS described in my above patent, several objects and advantages of the present novel invention are:
(a) to provide an efficient full function method and apparatus for inputting data into devices like computers, typewriters, calculators, telephones, remote controls, limited space mini keyboards, musical data input devices, and any mechanism or device requiring data input; requiring fewer or a lessor number of keys.
(b) to provide a simple and extensive full function method and apparatus for inputting data into devices like
computers, typewriters, calculators, telephones, remote controls, limited space mini keyboards, musical data input devices, and any mechanism or device requiring data input; which takes less effort to perform the keystrokes.
(c) to provide an efficient full function method and apparatus for inputting data into devices like computers, typewriters, calculators, telephones, remote controls, limited space mini keyboards, musical data input devices, and any mechanism or device requiring data input; which is simpler, easier, and less expensive to manufacture and can be made out of a variety of materials;
(d) to provide a full function method and apparatus for inputting data into devices like computers, typewriters, calculators, telephones, remote controls, limited space mini keyboards, musical data input devices, and any mechanism or device requiring data input; for languages that relatively have a large number of characters and would benefit from the fact that it takes a smaller number of keys to control the data input;
(e) to provide an efficient full function method and apparatus for inputting data into devices like computers,
typewriters, calculators, telephones, remote controls, limited space mini keyboards, musical data input devices, and any mechanism or device requiring data input; which is faster or can be accomplished in less time.
(f) to provide an efficient full function method and apparatus for inputting data into devices like computers,
typewriters, calculators, telephones, remote controls, limited space mini keyboards, musical data input devices, and any mechanism or device requiring data input; which is less burdensome, arduous, and laborious;
(g) to provide an efficient full function method and apparatus for inputting data into devices like computers,
typewriters, calculators, telephones, remote controls, limited space mini keyboards, musical data input devices, and any mechanism or device requiring data input; whereby the position or the location of the letter, number, or other function is located in a direction as is known or memorized in everyday operation like that of the STANDARD QUERTY KEYBOARD of said devices so that by the slight manipulation of the key in that same direction by the appropriate finger or key will result in the entry or input of the desired data. The functions may be reprogrammed to fit any of various systems other than the QWERTY KEYBOARD like the DVORAK KEYBOARD or basic calculator positions and telephone positions. In addition, a simple layout of a new positions for the required data can be programmed simply through electronic programming. number of keys;

Further objects and advantages are to provide a DATA INPUT METHOD AND APPARATUS which is easily manufactured and easy to use. Still further objects and advantages will become apparent from a consideration of the ensuing description and drawings.

### DRAWING FIGURES

The present invention will become more fully understood from the detailed description given hereinbelow and the accompanying drawings, which are given by way of illustration only, and thus, are not limitative of the present invention, and wherein:

FIG. 1 shows a top/overhead view of various aspects of a multidirectional key, in accordance with the present invention; illustrating how the apparatus utilizes this full function method for alphabetical and function data entry;

FIG. 2 shows a top/overhead view of various aspects of multidirectional keys, illustrating how the apparatus utilizes this full function method for numerical and function data entry;

FIG. 3 shows a front view of various aspects of multidirectional keys mounted on a hand rest; illustrating how the apparatus utilizes this full function method of data entry;

FIG. 4A shows a top/overhead view of various aspects of multidirectional keys mounted on a keyboard, illustrating how the apparatus utilizes this full function method of data entry;

FIG. 4B shows a front view of various aspects of multidirectional keys mounted on a keyboard, illustrating how the apparatus utilizes this full function method of data entry;

FIG. 4C shows a blown up side view of various aspects of a multidirectional key, illustrating the composition of a key on a keyboard utilizing the full function method of data entry;

FIG. 5A shows a top/overhead view of various aspects of multidirectional keys mounted on a circular keyboard, illustrating how the apparatus utilizes this full function method of data entry;

FIG. 5B shows a front view of various aspects of multidirectional keys mounted on a circular keyboard, illustrating how the apparatus utilizes this full function method of data entry;

### REFERENCE NUMERALS IN DRAWINGS

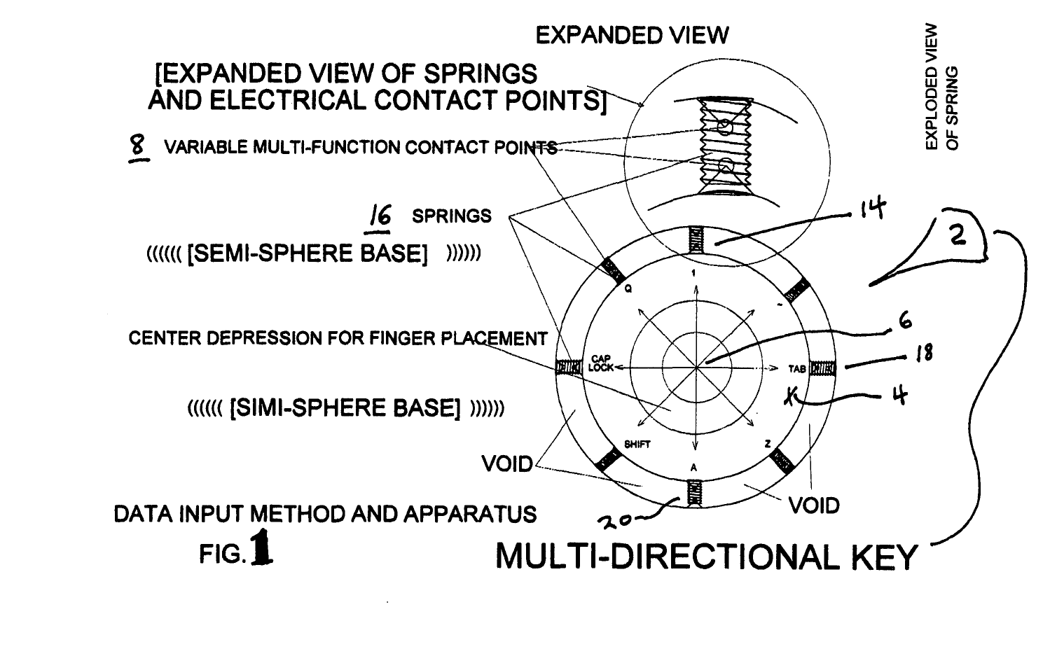

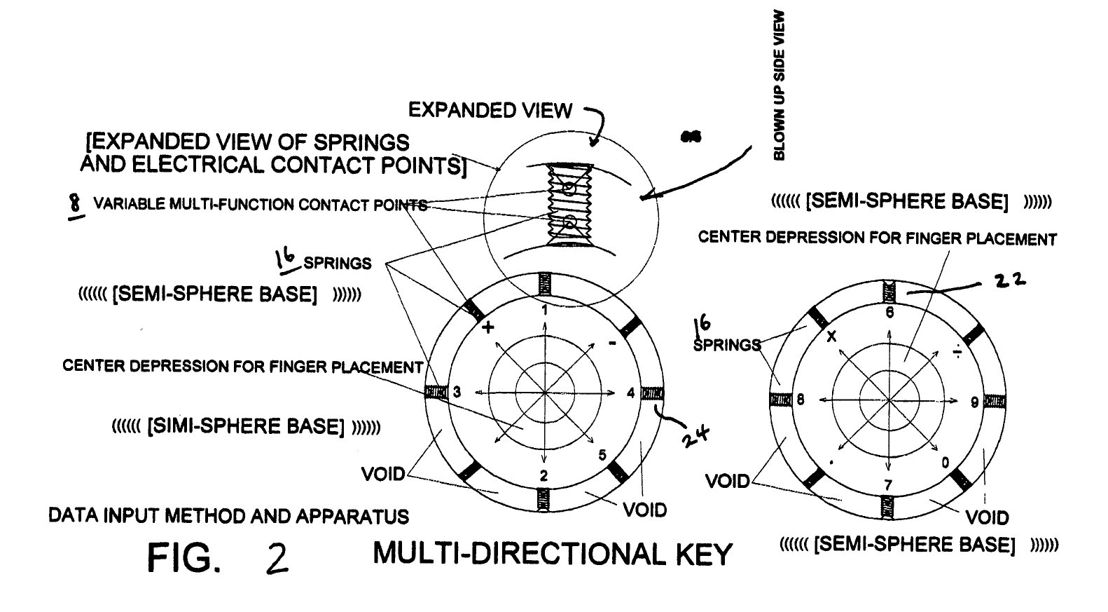

2 MULTI-DIRECTIONAL KEY
4 MOTION/MOVING SURFACE
6 KEY CENTERPOINT/REST POSITION
8 CONTACT POINT
14 CONTACT FOR NUMERAL 1
16 SPRING ACTION DEVICE
18 CONTACT FOR FUNCTION TAB
20 CONTACT FOR LETTER A
22 CONTACT FOR NUMERAL 6
24 CONTACT FOR NUMERAL 4
26 MULTIDIRECTIONAL KEYS
28 HAND REST
30 BASE
32 ADJUSTABLE SLIDING TRAY
34 ADJUSTING POST
   Description—FIG. 1-FIG. 2—Preferred Embodiment

With reference to a preferred embodiment of the DATA INPUT METHOD AND APPARATUS of the present invention is illustrated in FIGS. 1-2 [top/overhead view of a multi-directional key [apparatus] [1], as a means to accomplish the input method for encompassing all aspects of data entry for electronic devices as referred to herein. The multi-directional key [2] essentially comprises a mounted motion/moving surface [4] that is pushed in any [spherical/3-D] direction from a center point/rest position [6] toward a contact point [8]. Each contact point [8] when engaged inputs it's prearranged data in the conventional way; as example; contact for numeral 1 [14] contact for function tab [18] contact for letter A [20] contact for numeral 6 [22] contact for numeral 4 [24] are shown as well as many others. The motion/moving surface [4] is then returned into position via spring action device [16]. The contact arrangements may be set in various ways as desired. The apparatus for the method of motion shown may be devised in numerous ways, and made of conventional or alternative materials. The apparatus disclosed is only illustrated as a means of describing the DATA INPUT METHOD. The DATA INPUT METHOD is the simplicity of the manipulation performed with a slight movement of the finger[s], etc. Rather than reaching and locating a key with each finger, etc. which takes more time and effort, the fingers, etc. remain on a key and move the key slightly in the direction of the contact for the right data entry desired. In the case of a touch screen or the like, mental or electronic transmissions, and the like just the motion of the finger, other controlling indicator, and the like from any designated center-point toward or in the direction of the preset point of data contact however slight would cause the data to be input. This is a novel way of inputting all data characters. Languages with a relatively large number of characters have the advantage of having many input characters all on one multidirectional key thereby avoiding needing as many keys.

The method of manipulating a [spherical/3-D] multi-directional key from a center-point to any [spherical/3-D] direction as stated, is the invention here and there could be numerous devices or apparatus developed to accomplish the method as described.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

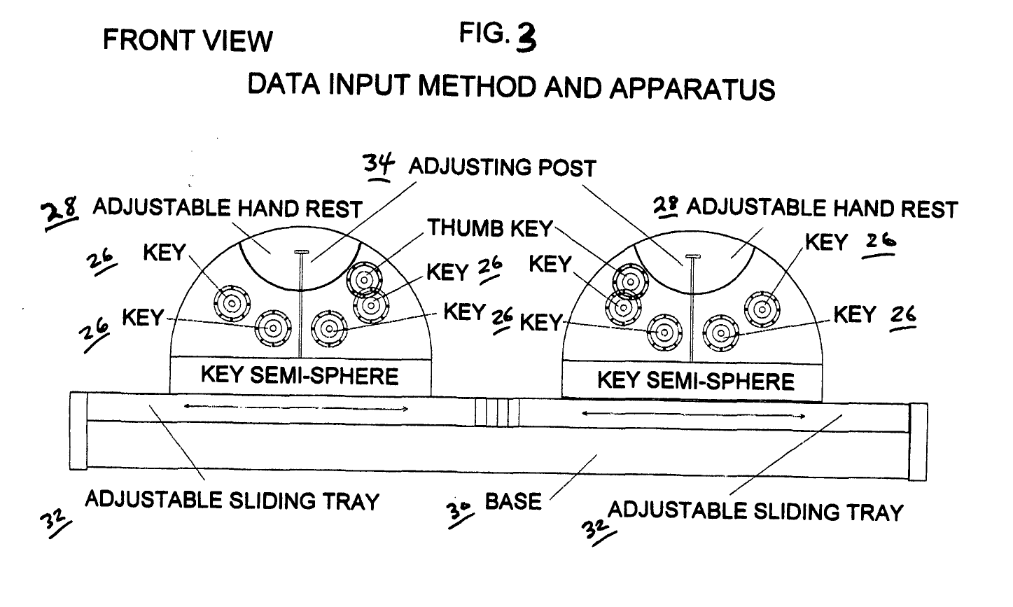

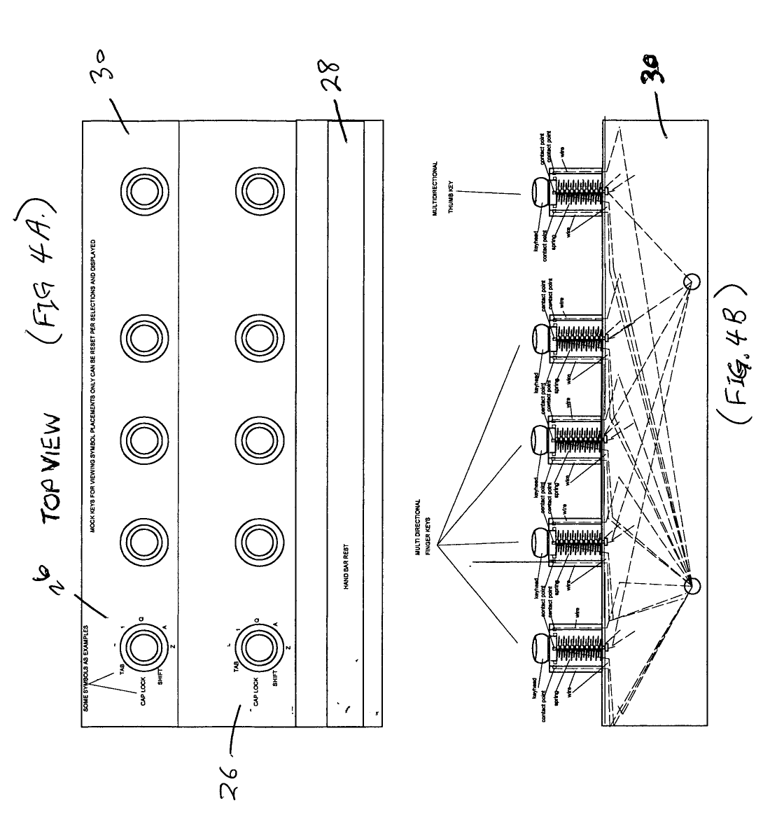

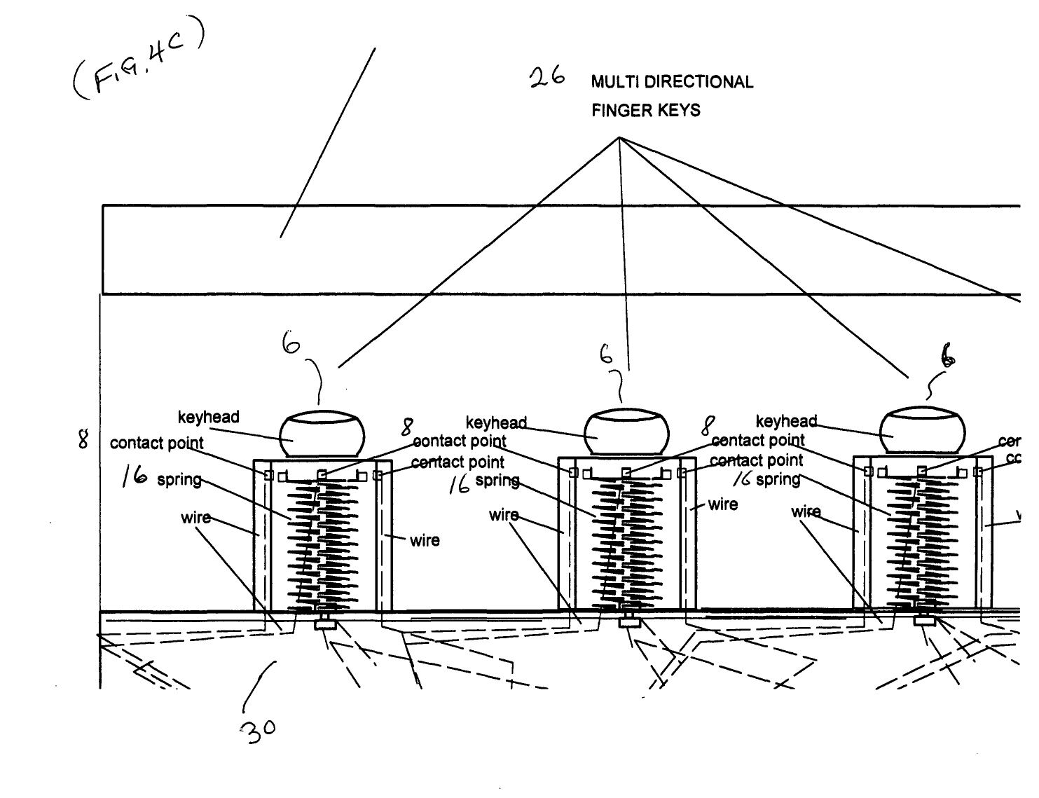

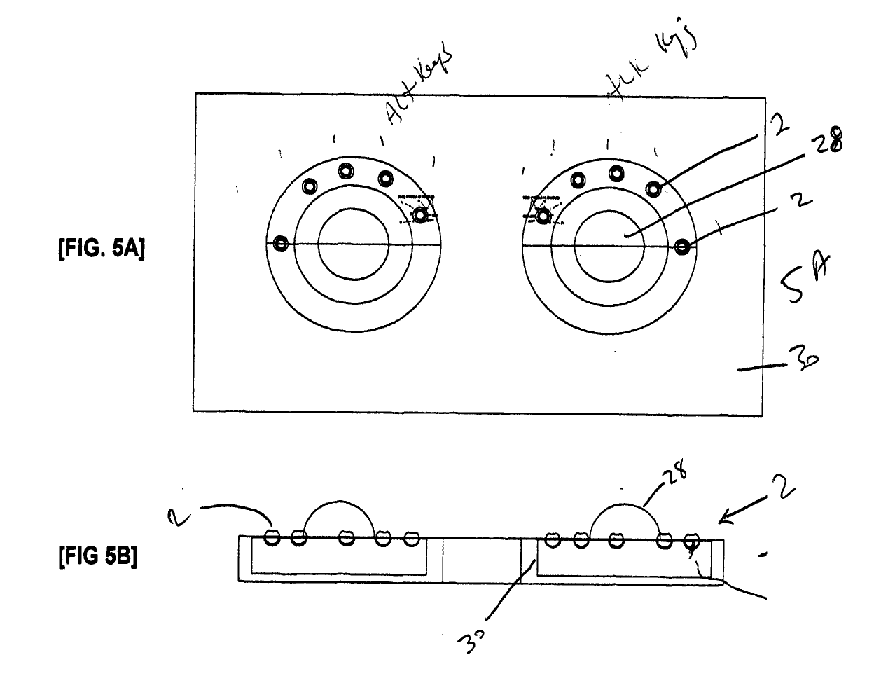

FIGS. 3-4C—Alternative Embodiments

In FIG. 3 the DATA INPUT METHOD AND APPARATUS is utilized by mounting multi-directional key [2] as key sets [26] on a hand rest type keyboard consisting of a base [30], adjustable sliding tray [32] adjusting posts for longer or shorter fingers, etc. [34] hand rests [28]. Keys are placed in various positions to accommodate the use of the keyboard

In FIG. 4A-C DATA INPUT METHOD AND APPARATUS is utilized by mounting multi-directional key [2] as key sets [26] on a Keyboard. Keys are placed in various positions to accommodate the use of the keyboard

All alternative embodiments have the same capability of incorporating any of the preferred or additional embodiments shown.

Advantages

From the description above, a number of advantages of the DATA INPUT METHOD AND APPARATUS become evident:
(a) Providing an efficient full function method and apparatus for inputting data into devices like computers, typewriters, calculators, telephones, remote controls, limited space mini keyboards, musical data input devices, and any mechanism or device requiring data input; requiring fewer or a lessor number of keys.

(b) Providing a simple and extensive full function method and apparatus for inputting data into devices like
computers, typewriters, calculators, telephones, remote controls, limited space mini keyboards, data input devices, and any mechanism or device requiring data input; which takes less effort to perform the keystrokes.

(c) Providing an efficient full function method and apparatus for inputting data into devices like computers, typewriters, calculators, telephones, remote controls, limited space mini keyboards, musical data input devices, and any mechanism or device requiring data input; which is simpler, easier, and less expensive to manufacture and can be made out of a variety of materials;
(d) Providing a full function method and apparatus for inputting data into devices like computer, typewriters, calculators, telephones, remote controls, limited space mini keyboards, musical data input devices, and any mechanism or device requiring data input; for languages that have a relatively large number of characters and would benefit from the fact that it takes a smaller number of keys to control the data input;
(e) Providing an efficient full function method and apparatus for inputting data faster into devices like computers,
typewriters, calculators, telephones, remote controls, limited space mini keyboards, musical data input devices, and any mechanism or device requiring data input; which is faster or can be accomplished in less time.
(f) Providing an efficient full function method and apparatus for inputting data into devices like computers,
typewriters, calculators, telephones, remote controls, limited space mini keyboards, and any mechanism or device requiring data input which is less burdensome, arduous, and laborious;
(g) Providing an efficient full function method and apparatus for inputting data into devices like computers, typewriters, calculators, telephones, remote controls, limited space mini keyboards, musical data input devices, and any mechanism or device requiring data input, whereby the position or the location of the letter, number, or other function is located in a direction as is known or memorized in everyday operation like that of the STANDARD QUERTY KEYBOARD of said devices so that by the slight manipulation of the key in that same direction by the appropriate finger or key will result in the entry or input of the desired data. The functions may be reprogrammed to fit any of various systems other than the QWERTY KEYBOARD like the DVORAK KEYBOARD or basic calculator positions and telephone positions. In addition, a simple layout of a new positions for the required data can be programmed simply through electronic programming.
   Operation—FIGS. 1-4

The manner of using the DATA INPUT METHOD AND APPARATUS is different but similar in a familiar way than what is presently done to inter data by typewriters, telephones, calculators, and the like. Rather than reaching, locating, and depressing a key with each finger, etc. which takes more time and effort, the fingers, etc. remain on a key unless otherwise necessary, etc. and manipulates the key, etc. with a slight movement of the finger, etc from a center point/rest position in any [spherical/3-D direction of the contact point for the right data entry desired. Once the contact is made, the data is electronically transmitted in conventional ways. Either the key, etc. moves back to center point/rest position by spring action device for the next manipulation or the key may be a touch screen or the like so any movement from the present location of the finger, etc. in any direction could trigger another contact for data entry. The touch screen or the like could identify the center point as wherever the finger, etc. is presently positioned and movement in any direction would trigger a contact for data input. The number of keys, etc. required or necessary would be determined by the applications required and the functions of the keys. Different numbers of functions could be applied/programmed electronically.

The direction in which the contact point lies may be programmed in many ways. One way The key or device for data entry could be made in a number of ways using the present method of manipulating a key. The method is basically multi-directional manipulation of a key, which may also include pushing the key straight down in conjunction with other multi-directional movements to allow an additional contact point for entry of data. The finger has to move only so slightly to manipulate the key to accomplish contact. The contact point for entry may be accomplished by a number of various means. Laser optics, various motion detector methods as used for a mouse, rolling key, flat plane key, or touch screen or the like are just a few of the means by which the method may be accomplished.

Contact points may be programmed to perform different or various functions. The contact points on the keys representing letters, numbers, symbols, function keys, and etc. could substantially follow the basic locations of a standard QWERTY or DVORAK KEYBOARD. This means for instance that in the QWERTY system the contact point where the key would be manipulated to for the A KEY would be right under the left little finger where the key could be manipulated straight down or straight back. The key for the Q contact point would be manipulated by the left little finger where the key could be manipulated diagonally up and to the left minutely mimicking the entry or movement or motion of the left little finger when it moves to strike the Q on a standard QWERTY KEYBOARD. The other letters, numbers, symbols, functions, and etc. would be similarly variable multi-functional contact points establishing data entry. On the other hand the keys could be reprogrammed for whatever entry positions would be easier for the user. A DVORAK KEYBOARD SYSTEM could be employed by simply resetting the program and the contact points are programmed to input different data as required

### CONCLUSION, RAMIFICATIONS, AND SCOPE

Accordingly, the reader will see that the DATA INPUT METHOD AND APPARATUS of this invention can be used to enter/input data easily, speedily, and conveniently. Further more, the DATA INPUT METHOD AND APPARATUS has additional advantages in that
It permits more full function data to be entered/input with less time and effort, speeding up the over all input process;
The fingers, etc. remaining on the key[s] most of the time rather than reaching and depressing hard to reach keys takes less time and effort.
The flexibility and the effortless freedom of the DATA INPUT METHOD AND APPARATUS allows easier use of data input devices in a way never known before;
The DATA INPUT METHOD AND APPARATUS allows the use of fewer keys, etc. to input data which is a great advantage for languages having a relatively large number of characters.

The DATA INPUT METHOD AND APPARATUS allows the use of fewer keys, etc. to input data allowing a better fit to smaller devices like cell phones, telephones, and the like.

The DATA INPUT METHOD AND APPARATUS allows that Multi-directional keys, etc. may be mounted in various ways on keyboards and hand rests to allow comfortable ways to use the data input method.
The DATA INPUT METHOD AND APPARATUS allows less strain of the hands and arms while entering the data which should help reduce strains and reduce the likelihood of injuries such as carpal tunnel syndrome.

Although the description above contains many specifications, these should not be construed as limiting the scope of the invention but as merely providing illustrations of some of the presently preferred embodiments of this invention. For example, The DATA INPUT METHOD AND APPARATUS can have many other features such as; different sizes/scale [relatively large to small], shapes, angularly devised parts thereof number of keys etc. and key, etc assemblies.

All alternate embodiments may incorporate the additional embodiments of the listed parts.

Thus the appended claims and their legal equivalents should determine the scope of the invention, rather than by the examples given.

I claim:

1. A novel DATA INPUT METHOD AND APPARATUS, which utilizes a method of utilizing multiple-directional keys having multiple-functions capable of performing all the tasks/functions required by computers, typewriters, calculators, telephones, remote controls, limited space mini keyboards, musical data input devices, and any mechanism or device requiring data input; whereby the user has the advantage of using a lesser number of multifunctional keys to input data faster and easier than would be necessary using single entry type keys.

2. The novel DATA INPUT METHOD AND APPARATUS, the method of claim 1, wherein said multi-directional keys and multi-function contact points are numerous as a means for engaging the method to control the full functionality of the computer, typewriter, calculator, telephone, remote control, limited space mini keyboard, musical data input device, and any mechanism or device requiring data input functions.

3. The novel DATA INPUT METHOD AND APPARATUS, the method of claim 1, wherein said Multi-directional keys are versatile and may be mounted on various keyboard types or hand rest type devices.

4. The novel DATA INPUT METHOD AND APPARATUS, the method of claim 1, wherein said method also applies to manipulating full function multidirectional keys, touch screen or like sensors, mental or electronic transmissions, and the like.

5. A novel DATA INPUT METHOD AND APPARATUS, the Apparatus as a means to accomplish the data input method comprises:
a multi-directional multiple function key means comprising;
a multi-directional motion/moving surface comprising a center point, and multiple contact points
wherein said motion/moving surface is multi-directional and wherein data input is accomplished when said motion/moving surface is moved slightly in any [spherical/3-D] direction from said center point toward said contact points.

6. The novel DATA INPUT METHOD AND APPARATUS, the apparatus as a means to accomplish the data input method of claim 5, wherein said
apparatus contact points are numerous for engaging complete computer, typewriter, calculator, telephone, remote control, limited space mini keyboard, musical data input device, and any mechanism or device requiring data input functions.

7. The novel DATA INPUT METHOD AND APPARATUS, the apparatus as a means to accomplish the data input method of claim 5, wherein said
apparatus Multi-directional keys are versatile and may be mounted on various keyboards or hand rest type devices.

8. The novel DATA INPUT METHOD AND APPARATUS, the apparatus as a means to accomplish the data input method of claim 5, wherein said
method also applies to manipulating multidirectional keys, touch screen or like sensors, mental or electronic transmissions, and the like.
